(19) United States
(12) Patent Application Publication
(10) Pub. No.: US 2018/0295806 A1
(43) Pub. Date: Oct. 18, 2018

(54) PET FEEDING DISH ASSEMBLY

(71) Applicant: Katrina DeVona, Plantsville, CT (US)

(72) Inventor: Katrina DeVona, Plantsville, CT (US)

(21) Appl. No.: 15/487,177

(22) Filed: Apr. 13, 2017

(51) Int. Cl. A01K 5/01; B65D 21/02

(52) U.S. Cl. CPC A01K 5/0114; B65D 21/0233

(57) ABSTRACT

A pet feeding dish assembly which includes an upstanding circumferential wall extending around and defining a concave chamber within the circumferential wall. The walls having an inner face and an outer face and a stop is disposed on the outer face of said circumferential wall. A cover is dimensioned and configured for nesting engagement with at least the upper extremity of said upstanding circumferential wall, said cover includes a recess dimensioned and configured for engagement with the stop on the outer face of the circumferential wall whereby the cover is prevented from rotating with respect to the upstanding circumferential wall.

### TECHNICAL FIELD

The present invention is generally directed to food serving products. More particularly, the present invention is directed to food serving products for dogs and cats as well as other pets.

### BACKGROUND OF THE INVENTION

The prior art includes various feeding dishes for dogs and cats. Pet feeding dishes are particularly vulnerable to accumulation of dried food products. The pet may not be a neat eater and/or may be a fussy eater resulting in particles of food drying on the feeding dish. Such dried food is both unpleasant in appearance as well as difficult to remove from the feeding dish.

From the above, it is therefore seen that there exists a need in the art to overcome the deficiencies and limitations described herein and above.

### SUMMARY OF THE INVENTION

The shortcomings of the prior art are overcome and additional advantages are provided through a pet feeding dish assembly which includes an upstanding circumferential wall extending around and defining a concave chamber within the circumferential wall. The walls having an inner face and an outer face and a stop is disposed on the outer face of said circumferential wall. A cover is dimensioned and configured for nesting engagement with at least the upper extremity of the upstanding circumferential wall. The cover includes a recess dimensioned and configured for engagement with the stop on the outer face of the circumferential wall whereby the cover is prevented from rotating with respect to the upstanding circumferential wall.

In some embodiments, the stop is a ring. The ring may have a uniform circular cross-section throughout the extent thereof and the ring may be symmetrical about a first virtual plane extending through the geometric center of each cross-section whereby the ring has a side face coincident with a second virtual plane that is parallel to the first virtual plane;

Accordingly, it is an object of the present invention to avoid the accumulation of dried food matter on a pet feeding dish.

It is another object of the present invention to provide an apparatus that facilitates cleanup of the pet feeding dish.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 it is an isometric view of a feeding dish in accordance with the present invention,

FIG. 2 is an isometric view illustrating the feeding dish shown in FIG. 1 in combination with a liner in accordance with one embodiment of the present invention,

FIG. 3 is another isometric view illustrating the feeding dish shown in FIG. 1 in combination with a liner in accordance with one embodiment of the present invention, and

FIG. 4 is an isometric view of the liner illustrated in FIGS. 2 and 3.

### DETAILED DESCRIPTION

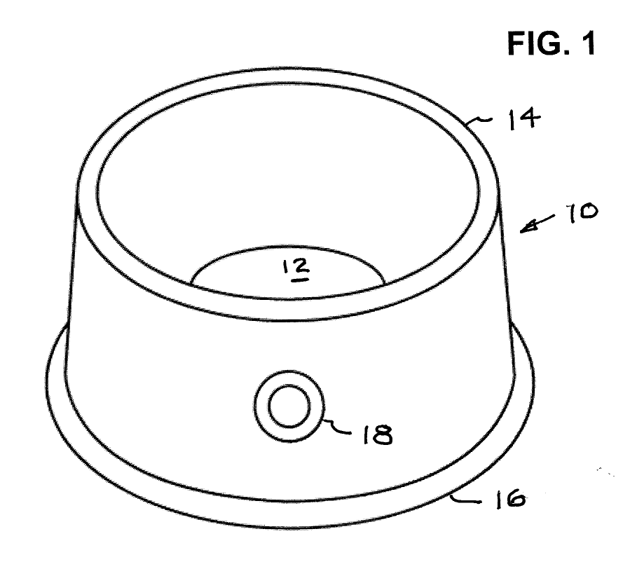

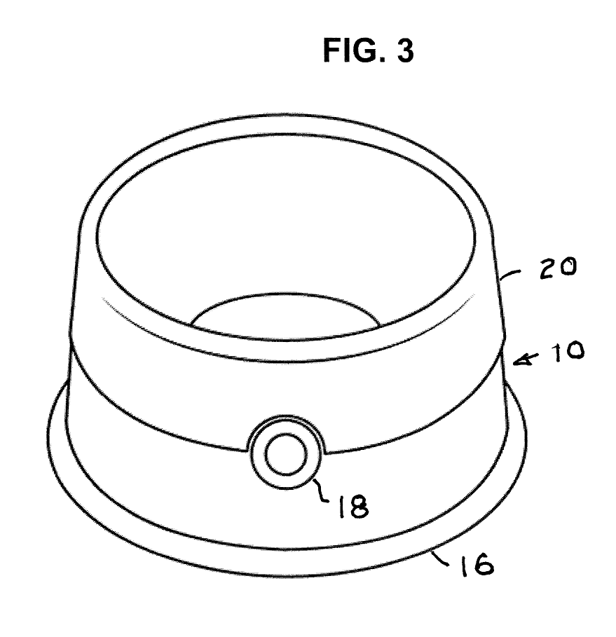

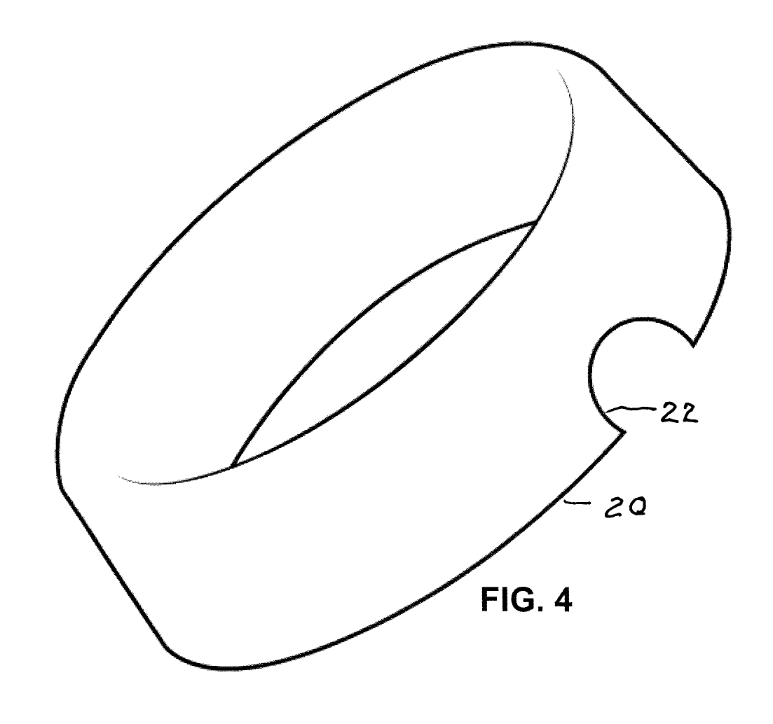

Referring now to FIGS. 1-4, a preferred embodiment utilizes a stainless steel dish 10 having a concave cavity with an upper rim 14. The dish 10 further includes a base 16 disposed at the base of the dish 10. The base is constructed to minimize any tipping of the dish 10. In preferred embodiments, the base 16 has a rubber or rubber like material composition to prevent sliding of the dish 10 with respect to the floor or any other surface on which the dish 10 is placed. Preferably the dish 10 is manufactured of stainless steel. A preferred embodiment includes a ring 18. The ring 18 in preferred embodiments has a circular cross-section that is uniform throughout the entire extent thereof. In addition, the circular cross-section of the ring 18 is bisected by a virtual plane that is coincident with the entire axis of the ring 18. A side face of the ring 18 is fixed to a side of the dish 10. The ring 18 may be manufactured of metal or plastic and may be attached to the dish 10 with adhesive, soldering, welding or other know joining techniques for the respective materials.

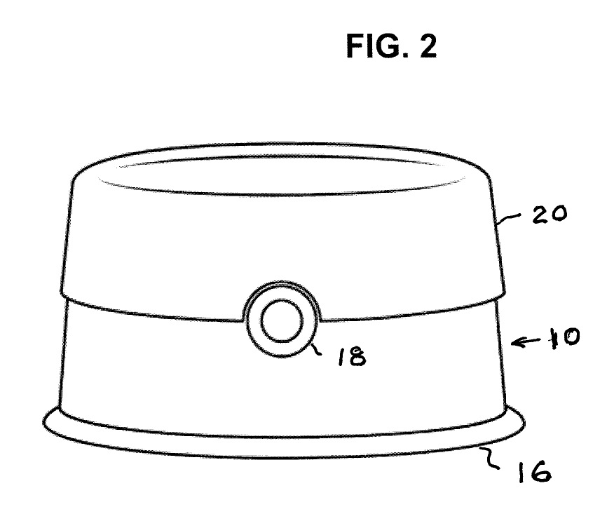

A replaceable cover 20 in accordance with a preferred embodiment of the present invention is shown in FIGS. 2-4. The replaceable cover 20 will ordinarily be manufactured of paper or plastic material that substantially prevents the passage of any liquid or solid through that cover. A preferred embodiment utilizes a durable paper plate material. The shape of the cover 20 in preferred embodiments results in a nesting engagement between the cover 20 and the dish 10. In most embodiments the cover 20 will have an arcuate recess 22 in the cover 20 that is dimensioned and configured for engaging the periphery of the ring 18 it is fixed to the face of the dish 10. More particularly, the cover 20 will have sufficient rigidity so that the engagement of the cover 20 with the periphery of the ring 18 prevents rotational movement of the, 20 with respect to the dish 10. More particularly, this engagement prevents rotational movement of the cover with respect to the dish when a pet is eating food that is disposed on the cover 20.

It will be understood that the ring 18 acts as a stop to prevent rotational movement. Other embodiments of the present invention may utilize a stop having a different shape that cooperate with an appropriate recess in the cover 22 prevent the rotational movement when the pet is eating from the assembly in accordance with the present invention.

The covers in accordance with the present invention are intended for one-time use. Accordingly, the caretaker for the pet is relieved of the onerous task of the tool remnants on the feeding dish. Advantageously the cover 20 does not move with respect to the dish 10 because of the stop such as the ring 18. In addition, the rubber like base 16 prevents the dish from moving with respect to the floor or other surface on which the dish may be disposed.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A pet feeding dish assembly which comprises:
an upstanding circumferential wall extending around and defining a concave chamber within the circumferential wall, said walls having an inner face and an outer face;
a stop disposed on the outer face of said circumferential wall;
a cover dimensioned and configured for nesting engagement with at least the upper extremity of said upstanding circumferential wall, said cover including a recess dimensioned and configured for engagement with said stop on the outer face of said circumferential wall whereby the said cover is prevented from rotating with respect to said upstanding circumferential wall.

2. A pet feeding dish assembly as described in claim 1 wherein said stop is a ring.

3. A pet feeding dish assembly as described in claim 2 wherein said ring has a uniform circular cross-section throughout the extent thereof and said ring is symmetrical about a first virtual plane extending through the geometric center of each cross-section whereby said ring has a side face coincident with a second virtual plane that is parallel to said first virtual plane;
